(19) United States
(12) Patent Application Publication
(10) Pub. No.: US 2007/0088147 A1
(43) Pub. Date: Apr. 19, 2007

(54) Epoxy resin, epoxy resin composition including the epoxy resin and method of preparing the epoxy resin

(76) Inventors: JongMoon Lee, Seoul (KR); JuKil Lee, Seoungnam-si (KR)

Correspondence Address: HARNESS, DICKEY & PIERCE, P.L.C., P.O. BOX 8910, RESTON, VA, 20195, US

(21) Appl. No.: 11/318,492

(22) Filed: Dec. 28, 2005

(30) Foreign Application Priority Data
Oct. 13, 2005 (KR) 10-2005-0096615

(51) Int. Cl. C08G 59/14

(52) U.S. Cl. 528/109; 528/119

(57) ABSTRACT

In an epoxy resin having improved adhesiveness and weather resistance, an epoxy resin composition including the epoxy resin and a method of preparing the epoxy resin, the epoxy resin is prepared by reacting about 40 to about 70 parts by weight of an epoxy compound including a triepoxy compound with about 30 to about 60 parts by weight of an aryl sulfonamide compound. The epoxy resin has enhanced adhesiveness and weather resistance, good compatibility with various solvents including polar solvents and non-polar solvents, and good compatibility with an acryl resin, a urethane resin, an alkyd resin and a melamine resin.

### CROSS-REFERENCE TO RELATED APPLICATIONS

This application claims priority under 35 USC § 119 to Korean Patent Application No. 2005-96615 filed on Oct. 13, 2005, the contents of which are herein incorporated by reference in their entirety.

### BACKGROUND OF THE INVENTION

1. Field of the Invention

The present invention relates to an epoxy resin, an epoxy resin composition including the epoxy resin and a method of preparing the epoxy resin. More particularly, the present invention relates to an epoxy resin having enhanced adhesiveness and weather resistance, an epoxy resin composition including the epoxy resin and a method of preparing the epoxy resin.

2. Description of the Related Arts

An epoxy resin composition generally has advantageous characteristics such as good tensile and mechanical strength, high adhesiveness and excellent resistances for abrasion, impact, an acid and a chemical. The epoxy resin composition having the characteristics is widely used for the engineering works and a building construction. For example, the epoxy resin composition exhibits good adhesiveness to a concrete surface, and has excellent chemical resistance and mechanical strength. Accordingly, the epoxy resin composition has been used as a waterproof material of an inner wall, an outer wall and a floor in a construction to prevent a crack thereof. In addition, the epoxy resin composition is used as a special coating agent in various industrial fields such as a textile, a paper, an automobile, a sport equipment, a timber, a construction, a s shipbuilding and marine engineering and the like.

Examples of the conventional natural seasoning resin include a thermoplastic acryl resin, an oxidized and polymerized alkyd resin and an acryl urethane resin, etc. The thermoplastic acryl resin provides a fast drying speed in a formation of a coating layer. However, the thermoplastic acryl resin has a very low solvent resistance and durability. The oxidized and polymerized alkyd resin undesirably has a drying time longer than about 5 days in a formation of a coating layer having sufficient physical characteristics. The oxidized and polymerized alkyd resin also has inferior chemical characteristics such as alkaline-resistance, solvent-resistance and the like. Although, in case of the acryl urethane resin, a coating layer has relatively good physical properties, the acryl urethane resin has two liquid systems to require an inconvenient mixing of two liquids immediately before the application. Moreover, when the acryl urethane resin is once mixed, a reaction proceeds even at a room temperature and a viscosity of the acryl urethane resin increases. Thus, a remaining resin cannot be stored.

The natural seasoning epoxy resin is generally prepared by a ring-opening reaction or a condensation reaction of an epoxy compound such as bisphenol A (BPA) epoxy with an acid compound such as a carboxylic acid or an aliphatic acid. In case of thus obtained one-liquid type natural seasoning epoxy resin, a coating layer has good properties. However, the natural seasoning epoxy resin has a poor weather resistance and an insufficient adhesiveness to a thin film. Furthermore, a solvent is restrictively used in accordance with a type of a monomer used in a formation of the epoxy resin.

To solve the above problems, there are still required a natural seasoning epoxy resin having enhanced adhesiveness and weather resistance, and an epoxy resin composition including the epoxy resin.

### SUMMARY OF THE INVENTION

Example embodiments of the present invention provide an epoxy resin having enhanced adhesiveness and weather resistance.

Example embodiments of the present invention also provide an epoxy resin composition including the epoxy resin.

Example embodiments of the present invention still also provide a method of preparing the epoxy resin.

According to one aspect of the present invention, an epoxy resin is prepared by reacting about 40 to about 70 parts by weight of an epoxy compound including a triepoxy compound with about 30 to about 60 parts by weight of an aryl sulfonamide compound. The epoxy resin may be prepared by reacting the epoxy compound, the aryl sulfonamide compound and a silane compound represented by a chemical formula 1,
R₁—(CH₂)ₙ—Si(R₂)ₓ(R₃)₃₋ₓ (1)

wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1. An example of the triepoxy compound may include a triglycidyl ether such as trimethylol propane triglycidyl ether. Examples of the aryl sulfonamide compound may include p-toluene sulfonamide, o-toluene sulfonamide and the like. The epoxy compound may further include a monoepoxy compound, a diepoxy compound or an epoxy prepolymer.

According to another aspect of the present invention, an epoxy resin is prepared by reacting about 40 to about 65 parts by weight of an epoxy compound including a triepoxy compound, an epoxy prepolymer and a combination thereof, about 30 to about 55 parts by weight of an aryl sulfonamide, and about 0.01 to about 20 parts by weight of a silane compound represented by a chemical formula 1,
R₁—(CH₂)ₙ—Si(R₂)ₓ(R₃)₃₋ₓ (1)

wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1.

According to still another aspect of the present invention, an epoxy resin composition includes about 50 to about 99.9 parts by weight of an epoxy resin and about 0.1 to about 50 parts by weight of an additive. The epoxy resin is prepared by reacting about 40 to about 70 parts by weight of an epoxy compound including a triepoxy compound and about 30 to about 60 parts by weight of an aryl sulfonamide compound. Examples of the additive include a viscosity-controlling agent, a plasticizer, a leveling agent, an anti-oxidizing agent, an anti-foaming agent and the like.

According to still another aspect of the present invention, an epoxy resin composition includes about 50 to about 99.9 parts by weight of an epoxy resin and about 0.1 to about 50 parts by weight of an additive. The epoxy resin is prepared by reacting about 40 to about 65 parts by weight of an epoxy compound including a triepoxy compound, an epoxy prepolymer or a combination thereof, about 30 to about 55 parts by weight of an aryl sulfonamide compound, and about 0.01 to about 20 parts by weight of a silane compound represented by a chemical formula 1,
R₁—CH₂)ₙ—Si(R₂)ₓ(R₃)₃₋ₓ (1)

wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1. Examples of the additive include a viscosity-controlling agent, a plasticizer, a leveling agent, an anti-oxidizing agent, an anti-foaming agent and the like.

According to still another aspect of the present invention, there is provided a method of preparing an epoxy resin. In the method, the epoxy resin is prepared by reacting about 40 to about 70 parts by weight of an epoxy compound including a triepoxy compound with about 30 to about 60 parts by weight of an aryl sulfonamide. The epoxy compound may be reacted with the aryl sulfonamide compound using a catalyst. Examples of the catalyst may include an ammonium salt, a borate salt, a phosphonium compound, an imidazole compound, a tertiary amine compound and the like. The epoxy compound may be reacted with the aryl sulfonamide compound at a temperature of about 60° C. to about 150° C.

According to still another aspect of the present invention, there is provided a method of preparing an epoxy resin. In the method, the epoxy resin is prepared by reacting about 40 to about 65 parts by weight of an epoxy compound, about 30 to about 55 parts by weight of an aryl sulfonamide compound, and about 0.01 to about 20 parts by weight of a silane compound represented by a chemical formula 1,
R₁—(CH₂)ₙ—Si(R₂)ₓ(R₃)₃₋ₓ (1 )

wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1. In one example embodiment of the present invention, an epoxy-silane compound may be prepared by reacting the epoxy compound with the silane compound, and then the epoxy-silane compound may be reacted with the aryl sulfonamide compound. In another example embodiment of the present invention, a sulfonamide-silane compound may be prepared by reacting the aryl sulfonamide compound with the silane compound, and then the sulfonamide-silane compound may be reacted with the epoxy compound.

According to the present invention, an epoxy resin prepared by reacting a triepoxy compound, an aryl sulfonamide compound and a silane compound exhibits improved adhesiveness and weather resistance. Furthermore, since both polar solvent and non-polar solvent can be applied for the epoxy resin, the epoxy resin has good compatibilities with various solvents, and good compatibilities with an acryl resin, a urethane resin, an alkyd resin, a melamine resin, etc.

### DETAILED DESCRIPTION OF THE INVENTION

The invention is described more fully hereinafter with reference to embodiments of the invention. The present invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First Epoxy Resin

A first epoxy resin of the present invention is prepared by reacting about 40 to about 70 parts by weight of an epoxy compound including a triepoxy compound and about 30 to about 60 parts by weight of an aryl sulfonamide compound.

When the amount of the epoxy compound included in the first epoxy resin is less than about 40 parts by weight, physical and chemical characteristics of a coating layer formed using the epoxy resin may be deteriorated. In addition, when the amount of the epoxy compound exceeds about 70 parts by weight, the weather resistance of the epoxy resin may be deteriorated. Therefore, the amount of the epoxy resin used in a preparation of the first epoxy resin is in the range of about 40 to about 70 parts by weight, preferably, in the range of about 45 to about 60 parts by weight.

The epoxy compound applied for the preparation of the first epoxy resin of the present invention includes a triepoxy compound. An example of the triepoxy compound may include a triglycidyl ether compound. Examples of the triglycidyl ether may include trimethylolpropane triglycidyl ether, triphenylolmethane triglycidyl ether, trimethylolethane triglycidyl ether, etc. These can be used alone or in a mixture thereof.

When the amount of the aryl sulfonamide compound used in the preparation of the first epoxy resin is less than about 30 parts by weight, resistance to ultraviolet radiation may be lowered, because an unreacted epoxy compound remains in the epoxy resin. In addition, when the amount of the aryl sulfonamide compound exceeds about 60 parts by weight, a coating layer may not be well formed using the epoxy resin, because an unreacted aryl sulfonamide compound remains in the epoxy resin. Therefore, the amount of the aryl sulfonamide compound used in the preparation of the first epoxy resin is in the range of about 30 to about 60 parts by weight, and preferably, in the range of about 40 to about 55 parts by weight.

Examples of the aryl sulfonamide compound that may be used in the preparation of the first epoxy resin according to the present invention may include p-toluene sulfonamide, o-toluene sulfonamide, benzene sulfonamide, naphthalene sulfonamide, and the like. These can be used alone or in a mixture thereof.

In an example embodiment of the present invention, the first epoxy resin is prepared by reacting the epoxy compound, the aryl sulfonamide compound and a silane compound represented by a chemical formula 1. The silane compound may serve to improve the adhesiveness of the epoxy resin.
R₁—(CH₂)ₙ—Si(R₂)ₓ(R₃)₃₋ₓ (1)

In the chemical formula 1, R₁ represents a vinyl group, a halogen atom, a thiol group, an epoxy group, an acryl group or an amino group, R₂ represents an alkyl group having 1 to 3 carbon atoms, R₃ represents an alkoxy group, n represents an integer of 0 to 3 and x represents 0 or 1.

When the first epoxy resin is prepared using the epoxy compound, the aryl sulfonamide compound and the silane compound, the epoxy resin may be prepared by reacting about 40 to about 65 parts by weight of the epoxy compound, about 30 to about 55 parts by weight of the aryl sulfonamide compound and about 0.01 to about 20 parts by weight of the silane compound, based on a total weight of the epoxy resin.

In the first epoxy resin according to an embodiment of the present invention, when the amount of the silane compound is less than about 0.01 parts by weight, the adhesiveness of the epoxy resin may not be sufficiently enhanced. In addition, when the amount of the silane compound exceeds about 20 parts by weight, a coating layer having a desirable mechanical strength may not be formed using the epoxy resin. Therefore, the amount of the silane compound used for the preparation of the first epoxy resin is preferably in the range of about 0.01 to about 20 parts by weight, and more preferably, in the range of about 1 to about 10 parts by weight.

Examples of the silane compound that may be used in the preparation of the first epoxy resin may include vinyltrimethoxy silane, vinyltriethoxy silane, tris(2-methoxyethoxy)(vinyl) silane, (3-bromopropyl)trimethoxy silane, (3-chloropropyl)trimethoxy silane, (3-bromopropyl)triethoxy silane, (3-chloropropyl)triethoxy silane, N-(2-aminoethyl) 3-amino-propyl-dimethoxymethyl silane, (3-aminopropyl)triethoxy silane, (3-aminopropyl)trimethoxy silane, (3-glycidyloxypropyl)trimethoxy silane, (3-glycidyloxypropyl)triethoxy silane, (3-mercaptopropyl)triethoxy silane, (3-mercaptopropyl)trimethoxy silane, 3-(methacryl)propyl triethoxy silane and the like. These can be used alone or in a mixture thereof.

In an example embodiment of the present invention, the first epoxy resin may be prepared by using the silane compound such as (3-glycidyloxypropyl)trimethoxy silane, N-(2-aminoethyl) 3-amino-propyl-dimethoxy methyl silane or a mixture thereof.

In an example embodiment of the present invention, the first epoxy resin may further include a monoepoxy compound, a diepoxy compound or a combination thereof along with the triepoxy compound.

Examples of the monoepoxy compound may include an aliphatic glycidyl ether, a carboxylic glycidyl ether, an aromatic glycidyl ether, a cyclic aliphatic glycidyl ether, etc. Particularly, examples of the monoepoxy compound may include butyl glycidyl ether, phenyl glycidyl ether, ethylhexyl glycidyl ether, allyl glycidyl ether, cresyl glycidyl ether and the like. These can be used alone or in a mixture thereof.

Examples of the diepoxy compound may include hexanediol diglycidyl ether, butanediol diglycidyl ether, bisphenol A diglycidyl ether, bisphenol F diglycidyl ether, bisphenol AF diglycidyl ether and ethylene glycol diglycidyl ether. These can be used alone or in a mixture thereof.

In an example embodiment of the present invention, the epoxy compound used in the preparation of the first epoxy resin may further include an epoxy prepolymer. Examples of the epoxy prepolymer may include bisphenol A (BPA) epoxy resin having a weight average molecular weight less than or equal to about 400, bisphenol F (BPF) epoxy resin having a weight average molecular weight less than or equal to about 400, bisphenol AF (BPAF) epoxy resin having a weight average molecular weight less than or equal to about 400, phenol-based epoxy resin having a weight average molecular weight less than or equal to about 1000, cresol-based epoxy resin having a weight average molecular weight less than or equal to about 1000, cyclic aliphatic epoxy resin having a weight average molecular weight less than or equal to about 1000 and the like. These can be used alone or in a mixture thereof.

When the bisphenol-based epoxy compound is used along with the triepoxy compound as the epoxy compound according to an embodiment of the present invention, the preferred epoxy equivalent of the bisphenol-based epoxy compound is about 50 to about 95 percent based on a total epoxy equivalent of the epoxy compound. When the epoxy equivalent of the bisphenol-based epoxy compound is less than about 50 percent, mechanical characteristics of a coating layer formed using the epoxy resin may be deteriorated. In addition, when the epoxy equivalent of the bisphenol-based epoxy compound exceeds about 95 percent, the weather resistance of the coating layer may be deteriorated. Therefore, the epoxy compound used in the preparation of the first epoxy resin according to an example embodiment of the present invention may preferably include a bisphenol-based epoxy compound having an epoxy equivalent of about 50 to about 95%, more preferably, an epoxy equivalent of about 65 to about 75%.

Second Epoxy Resin

A second epoxy resin of the present invention is prepared by reacting about 40 to about 65 parts by weight of an epoxy compound including a triepoxy compound, an epoxy prepolymer and a mixture thereof, about 0.01 to about 20 parts by weight of a silane compound represented by the chemical formula 1, and about 30 to about 55 parts by weight of an aryl sulfonamide compound.
R₁—(CH₂)ₙ—Si(R₂)ₓ(R₃)₃₋ₓ (1)

In the chemical formula 1, R₁ represents a vinyl group, a halogen atom, a thiol group, an epoxy group, an acryl group or an amino group, R₂ represents an alkyl group having 1 to 3 carbon atoms, R₃ represents an alkoxy group, n represents an integer of 0 to 3 and x represents 0 or 1.

The epoxy compound, the triepoxy compound, the epoxy prepolymer, the silane compound and the aryl sulfonamide compound are previously described in the first epoxy resin, so any further descriptions will be omitted.

In an example embodiment of the present invention, the epoxy compound used in the preparation of the second epoxy resin may further include a monoepoxy compound, a diepoxy compound and a combination thereof. The monoepoxy compound and the diepoxy compound are previously described in the first epoxy resin, so any further descriptions will be omitted.

First Epoxy Resin Composition

A first epoxy resin composition includes about 50 to about 99.9 parts by weight of an epoxy resin and about 0.1 to about 50 parts by weight of an additive. The epoxy resin is prepared by reacting about 40 to about 70 parts by weight of an epoxy compound including a triepoxy compound and about 30 to about 60 parts by weight of an aryl sulfonamide compound. Examples of the additive include a viscosity-controlling agent, a plasticizer, a leveling agent, an anti-oxidizing agent, an anti-foaming agent and the like. The epoxy resin is previously described in the first epoxy resin, so any further descriptions will be omitted.

The amount of the epoxy resin, and the type and the amount of the additive included in the first epoxy resin composition may be adjustable in accordance with utilities of the composition.

When the first epoxy resin composition according to the present invention includes less than about 50 parts by weight of the epoxy resin and greater than about 50 parts by weight of the additive, the epoxy resin may not sufficiently function as a main binder in a formation of a coating layer so that mechanical characteristics of the coating layer may be deteriorated. In addition, when the amount of the epoxy resin exceeds about 99.9 parts by weight and the amount of the additive is less than about 0.1 part by weight, the viscosity of the first epoxy resin composition may not be easily controlled, so that characteristics such as working efficiency, weather resistance, appearance, etc. may be also deteriorated. Therefore, the first epoxy resin composition of the present invention includes about 50 to about 99.9 parts by weight of the epoxy resin and about 0.1 to about 50 parts by weight of the additive.

Examples of the viscosity-controlling agent that may be used in the first epoxy resin composition of the present invention may include a ketone compound, an ester compound, an aromatic hydrocarbon compound, etc. These can be used alone or in a mixture thereof. Examples of the ketone compound may include methyl ethyl ketone, acetone or a mixture thereof. Examples of the ester compound may include butyl acetate, ethyl acetate and a mixture thereof. Examples of the aromatic hydrocarbon compound may include toluene, xylene and a mixture thereof.

Examples of the plasticizer that may be used in the first epoxy resin composition of the present invention may include dioctyl phthalate, dibutyl phthalate, dimethyl phthalate, diethyl phthalate, dioctyl adipate, dioctyl sebacate, etc. These can be used alone or in a mixture thereof.

Examples of the leveling agent that may be used in the first epoxy resin composition of the present invention may include BYK-320, BYK-331 (trade names; manufactured by BYK Chemie Co., Ltd., Germany), etc. An example of the anti-oxidizing agent may include Tinuvin-292 (trade name; manufactured by Ciba Specialty Chemicals Co., Ltd., Switzerland). Further, examples of the anti-foaming agent that may be used in the first epoxy resin composition of the present invention may include BYK-066, BYK-067, BYK-067A, BYK-354 (trade names; manufactured by BYK Chemie Co., Ltd., Germany), etc.

Second Epoxy Resin Composition

A second epoxy resin composition of the present invention includes about 50 to about 99.9 parts by weight of an epoxy resin and about 0.1 to about 50 parts by weight of an additive. The epoxy resin is prepared by reacting about 40 to about 65 parts by weight of an epoxy compound including a triepoxy compound, an epoxy prepolymer or a mixture thereof, about 30 to about 55 parts by weight of an aryl sulfonamide compound, and about 0.01 to about 20 parts by weight of a silane compound represented by a chemical formula 1,
R₁—(CH₂)ₙ—Si(R₂)ₓ(R₃)₃₋ₓ (1)

wherein R₁ represents a vinyl group, a halogen atom, a thiol group, an epoxy group, an acryl group or an amino group, R₂ represents an alkyl group having 1 to 3 carbon atoms, R₃ represents an alkoxy group, n represents an integer of 0 to 3 and x represents 0 or 1. Examples of the additive include a viscosity-controlling agent, a plasticizer, a leveling agent, an anti-oxidizing agent, an anti-foaming agent and the like. The epoxy resin is previously described in the second epoxy resin, so any further descriptions will be omitted.

Method of Preparing Epoxy Resin

A method of preparing a first epoxy resin according to the present invention will be fully described hereinafter. The first epoxy resin is prepared by reacting about 40 to about 70 parts by weight of an epoxy compound including a triepoxy compound and about 30 to about 60 parts by weight of an aryl sulfonamide compound. The epoxy compound and the aryl sulfonamide compound are previously described, so any further detailed descriptions will be omitted.

In an example embodiment of the present invention, a reaction of the epoxy compound with the aryl sulfonamide compound may be performed in the presence of a catalyst. Examples of the catalyst that may be used in the preparation of the first epoxy resin may include an ammonium salt, a borate salt, a phosphonium compound, an imidazole compound, a tertiary amine compound and a mixture thereof. Particularly, examples of the catalyst may include triethyl ammonium chloride, triethyl ammonium bromide, triethyl ammonium iodide, tributyl ammonium chloride, tributyl ammonium bromide, tributyl ammonium iodide, tetraethyl ammonium tetrafluoroborate, N,N-dimethyl-1,2-diaminoethane-tetrafluoroboric acid, ethyl triphenyl phosphonium chloride, ethyl triphenyl phosphonium iodide, imidazole, 1-methyl imidazole, benzimidazole, trimethyl amine, triethyl amine, tripropyl amine, tributyl amine, and the like. These can be used alone or in a mixture thereof.

When the temperature of the reaction between the epoxy compound and the aryl sulfonamide compound is less than about 60° C., the functional group of the epoxy compound may not be sufficiently activated and thus the reaction of the epoxy compound with the aryl sulfonamide compound may not easily proceed. In addition, when the reaction temperature exceeds about 150° C., side reactions may be unpreferably generated besides an epoxy ring-opening reaction, and a control of the reaction may be difficult. Therefore, the reaction between the epoxy compound and the aryl sulfonamide compound may be preferably performed at a temperature of about 60° C. to about 150° C., more preferably, at a temperature of about 80° C. to about 130° C.

The reaction of the epoxy compound with the aryl sulfonamide compound may be implemented using a stirrer that may sufficiently mix the reactants, so that the reaction may well proceed. Furthermore, the reaction of the epoxy compound with the aryl sulfonamide compound may be carried out using a solvent such as butyl acetate, ethyl acetate, etc.

A method of preparing a second epoxy resin according to the present invention will be fully described hereinafter. The second epoxy resin is prepared by reacting about 40 to about 65 parts by weight of an epoxy compound, about 30 to about 55 parts by weight of an aryl sulfonamide compound, and about 0.01 to about 20 parts by weight of a silane compound represented by a chemical formula 1.
R₁—(CH₂)ₙ—Si(R₂)ₓ(R₃)₃₋ₓ (1)

In the chemical formula 1, R₁ represents a vinyl group, a halogen atom, a thiol group, an epoxy group, an acryl group or an amino group, R₂ represents an alkyl group having 1 to 3 carbon atoms, R₃ represents an alkoxy group, n represents an integer of 0 to 3 and x represents 0 or 1.

The epoxy compound, the silane compound and the aryl sulfonamide compound are previously described in the second epoxy resin, so any further descriptions will be omitted.

In one example embodiment of the present invention, an epoxy-silane compound may be prepared by reacting the epoxy compound with the silane compound, and then the second epoxy resin may be prepared by reacting the epoxy-silane compound with the aryl sulfonamide compound.

In another example embodiment of the present invention, a sulfonamide-silane compound may be prepared by reacting the aryl sulfonamide compound with the silane compound, and then the second epoxy resin may be prepared by reacting the sulfonamide-silane compound with the epoxy compound.

The catalyst, the reaction temperature, the stirring, the solvent, etc. are previously described in the preparation of the first epoxy resin, so any further descriptions will be omitted.

Method of Preparing Epoxy Resin Composition

After the epoxy resin is prepared using the method previously described, the epoxy resin composition is prepared by mixing the epoxy resin and the additive. The epoxy resin and the additive are previously described, so any further descriptions will be omitted.

In an example embodiment of the present invention, the epoxy resin may be mixed with the additive using a stirrer at a room temperature. Mixing of the epoxy resin and the additive may be carried out for longer than or equal to about 30 minutes. The epoxy resin composition according to the present invention is a natural drying-type resin composition. For example, the epoxy resin composition is sufficiently dried at a room temperature for about 7 days.

The present invention will be further described with reference to Examples and Comparative Examples, hereinafter.

Preparation of Epoxy Resin

### EXAMPLE 1

A thermometer and a condenser were installed in a 1 L four-necked flask, and then the flask was placed on a stirrer and a heater. About 120 g of p-toluene sulfonamide, about 120 g of butyl acetate and about 500 ppm of triethylammonium chloride used as a catalyst were added into the flask, and then the mixture was sufficiently stirred. About 130 g of trimethylol propane N-triglycidyl ether used as an epoxy compound was added into the mixture. The epoxy ring-opening reaction was implemented at a temperature of about 80° C., until the viscosity of the resulting mixture reached to Y to Z3 by Gardner Viscosity. As a result, an epoxy resin was obtained.

### EXAMPLE 2

About 25 g of (3-glycidyloxypropyl)trimethoxy silane, about 120 g of p-toluene sulfonamide, about 120 g of butyl acetate and about 500 ppm of triethyl ammonium chloride used as a catalyst were reacted at a temperature of about 80° C. for about 2 hours. About 130 g of trimethylol propane N-triglycidyl ether used as an epoxy compound was added into the mixture. The epoxy ring-opening reaction was implemented at a temperature of about 100° C., until the viscosity of the resulting 15 mixture reached to Y to Z3 by Gardner Viscosity. As a result, an epoxy resin was obtained.

### EXAMPLE 3

An epoxy resin was prepared by processes substantially same as those described in Example 2 except that about 180 g of bisphenol A type epoxy prepolymer having an epoxy equivalent of 190 was used as the epoxy compound.

### EXAMPLE 4

An epoxy resin was prepared by processes substantially same as those described in Example 2 except that about 95 g of bisphenol A type epoxy prepolymer having an epoxy equivalent of 190 and about 55 g of trimethylol propane N-triglycidyl ether were used as the epoxy compound.

### EXAMPLE 5

An epoxy resin was prepared by processes substantially same as those described in Example 2 except that about 95 g of bisphenol A type epoxy prepolymer having an epoxy equivalent of 190, about 55 g of trimethylol propane N-triglycidyl ether and about 30 g of neodecanoic acid glycidyl ester were used as the epoxy compound.

### EXAMPLE 6

About 20 g of N-(2-aminoethyl) 3-amino-propyl-dimethoxy methyl silane, about 130 g of trimethylol propane N-triglycidyl ether, about 120 g of butyl acetate and about 500ppm of triethylammonium chloride used as a catalyst were added into a flask and stirred at a temperature of about 80° C. for about 2 hours. About 120 g of p-toluene sulfonamide was added into the mixture. An epoxy ring-opening reaction was performed at a temperature of about 100° C. until the viscosity of the resulting mixture reached to Z to Z1 by Gardner Viscosity. As a result, an epoxy resin was obtained.

### COMPARATIVE EXAMPLE 1

About 120 g of p-toluene sulfonamide, about 120 g of butyl acetate and about 500 ppm of triethylammonium chloride used as a catalyst were added into a flask, and were stirred sufficiently. About 180 g of bisphenol A type epoxy prepolymer having an epoxy equivalent of 190 was added into a mixture. The reaction was performed, until the viscosity of the resulting mixture reached to Y to Z3 by Gardner Viscosity. As a result, an epoxy resin was obtained.

Preparation of Epoxy Resin Composition

### EXAMPLE 7

About 300 g of the epoxy resin prepared by Example 1, about 1 g of a leveling agent, about 1 g of a anti-foaming agent, about 3 g of an anti-oxidizing agent, about 10 g of a plasticizer and about 60 g of a viscosity-controlling agent were sufficiently mixed at a room temperature for about 30 minutes. The mixture was left at a room temperature for about 7 days to prepare a naturally dried epoxy resin composition. BYK-320 (trade 15 name; manufactured by BYK Chemie Co., Ltd., Germany) was used as the leveling agent. Tinuvin-292 (trade name; manufactured by Ciba Specialty Chemicals Co., Ltd., Switzerland) was used as the anti-oxidizing agent. Dibutyl phthalate was used as the plasticizer. Butyl acetate was used as the viscosity-controlling agent. BYK-066 (trade name; manufactured by BYK Chemie Co., Ltd., Germany) was used as the anti-foaming agent. The epoxy resin composition thus obtained had a glass transition temperature (Tg) of about 30° C., which was measured using a Differential Scanning Calorimetry (DSC).

### EXAMPLE 8 to 12

Epoxy resin compositions were prepared by processes substantially same as those described in Example 7 except that the epoxy resins prepared in Examples 2 to 6 were used instead of the epoxy resin prepared in Example 1, respectively. Glass transition temperatures (Tg) of the epoxy resin compositions thus obtained are shown in the following Table 1.

### COMPARATIVE EXAMPLE 2

A epoxy resin composition was prepared by processes substantially same as those described in Example 7 except that the epoxy resin prepared in Comparative Example 1 was used instead of the epoxy resin prepared in Example 1. The glass transition temperature (Tg) of the epoxy resin composition thus obtained is shown in the following Table 1.

TABLE 1

| Epoxy Resin | Glass Transition |
|---|---|
| Composition | Temperature (Tg) [° C.] |
| Example 7 | 30 |
| Example 8 | 32 |
| Example 9 | 42 |
| Example 10 | 35 |
| Example 11 | 37 |
| Example 12 | 33 |
| Comparative Example 2 | 40 |

Evaluation on Adhesiveness and Weather Resistance

Adhesiveness and weather resistance of coating layers formed using the epoxy resin compositions prepared in Examples 7 to 12 and Comparative Example 2 were evaluated.

In order to evaluate adhesiveness and weather resistance, steel sheets polished using sandpaper and degreased were prepared. The steel sheets were coated with the epoxy resin compositions prepared in Examples 7 to 12 and Comparative Example 2, respectively. The thickness of the coating layer was measured by about 15-20 μm. The coating layer formed on the steel sheet was dried at a room temperature for about 7 days. Adhesiveness and accelerated weather resistance of the coating layer thus obtained were tested.

The adhesiveness was evaluated by using an ASTM-D3359 method, which is a standard method of measuring the adhesiveness. The evaluation on the accelerated weather resistance was carried out using QUV and WOM (Weather-O-Meter). Each sample containing the coating layer was put into the QUV tester and tested for about 100 hours. A discoloration, a decolorized degree and a gloss change were observed. The WOM test was implemented by exposing the samples to ultraviolet rays, while the temperature and the humidity were changed. The results are shown in the following Table 2.

TABLE 2

| | | Weather Resistance | | |
|---|---|---|---|---|
| | Adhesiveness | QUV | WOM | Drying Time (day) |
| Example 7 | 4B | ⊚ | ◯ | 2 |
| Example 8 | 5B | ⊚ | ⊚ | 2 |
| Example 9 | 5B | Δ | Δ | 2 |
| Example 10 | 5B | ◯ | Δ | 2 |
| Example 11 | 5B | ◯ | Δ | 3 |
| Example 12 | 5B | ⊚ | ⊚ | 2 |
| Comparative | 4B | Δ | X | 2 |
| example 2 | | | | |

In the Table 2,
⊚ represents excellent,
◯ represents good,
Δ represents average and
X represents poor.

In the ASTM-D3359 test for evaluating the adhesiveness, the coating layer was divided into 100 partitions by carving lines on the coating layer using a knife. After a 10 standard tape was attached onto the coating layer or detached from the coating layer, it was confirmed whether the coating layer adhered to the steel sheet or not. The adhesiveness was evaluated by a scale of 5B, 4B, 3B, 2B, 1B and 0B, in which 5B represents a best adhesiveness.

As shown in Table 2, the coating layers formed using the epoxy resin compositions prepared according to the present invention had excellent adhesiveness of 4B or 5B. Further, in the QUV and the WOM tests, the coating layers formed using the epoxy resin compositions prepared according to the present invention had good weather resistances. The coating layers had relatively good UV resistance. The color and the gloss of the coating layers were not largely changed by heat and moisture.

The natural dryness of the coating layer was confirmed by measuring the finger-contacting drying time. After the coating layer was dried for a given period of time, the tacking degree of the coating layer was confirmed by contacting the coating layer with a hand. The drying speed of the coating layer was evaluated by measuring a time needed for reaching a tacky free state. The finger-contacting drying times of the coating layers formed using the epoxy resin compositions prepared according to the present invention were about 2-3 days. Therefore, it was confirmed that the coating layer formed using the epoxy resin composition of the present invention had good natural drying characteristics.

According to the present invention, the epoxy resin composition may have good adhesiveness and enhanced weather resistance that has been pointed as a defect of the conventional bisphenol A type epoxy resin. -In addition, the epoxy resin composition may have good solvent compatibility irrespective of types of solvents such as polar or non-polar solvent. Thus, the epoxy resin composition may be well miscible with polar and non-polar solvents. Furthermore, the epoxy resin composition has excellent compatibility with various resins such as an acryl resin, a urethane resin, an alkyd resin, a melamine resin, etc. Therefore, the epoxy resin and the epoxy resin composition according to the present invention may be used as a corrosion-inhibiting coating agent, a rust-inhibiting agent and a moisture-proofing agent for various substrates including iron or nonferrous metal. The epoxy resin and the epoxy resin composition may also be used as a reforming agent of various resins and an coating agent applicable to various industrial fields such as a fiber, an automobile, a sport equipment, a pulp, a construction, a shipbuilding and marine engineering, and the like.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. An epoxy resin prepared by reacting about 40 to about 70 parts by weight of an epoxy compound including a triepoxy compound with about 30 to about 60 parts by weight of an aryl sulfonamide compound.

2. The epoxy resin of claim 1, wherein the epoxy resin is prepared by reacting the epoxy compound, the aryl sulfonamide compound and a silane compound represented by a chemical formula 1,
R₁—(CH₂)ₙ—Si(R₂)ₓ(R₃)₃₋ₓ (1)
wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1.

3. The epoxy resin of claim 2, wherein the epoxy resin is prepared by reacting about 40 to about 65 parts by weight of the epoxy compound, about 30 to about 55 parts by weight of the aryl sulfonamide compound and about 0.01 to about 20 parts by weight of the silane compound, based on a total weight of the epoxy resin.

4. The epoxy resin of claim 2, wherein the silane compound comprises at least one selected from the group consisting of vinyltrimethoxy silane, vinyltriethoxy silane, tris(2-methoxyethoxy)(vinyl)silane, (3-bromopropyl)trimethoxy silane, (3-chloropropyl)trimethoxy silane, (3-bromopropyl)trimethoxy silane, (3-chloropropyl)triethoxy silane, N-(2-aminoethyl) 3-amino-propyl-dimethoxymethyl silane, (3-aminopropyl)trimethoxy silane, (3-aminopropyl)trimethoxy silane, (3-glycidyloxypropyl)trimethoxy silane, (3-glycidyloxypropyl)trimethoxy silane, (3-mercaptopropyl)trimethoxy silane, (3-mercaptopropyl)trimethoxy silane and 3-(methacryl)propyl triethoxy silane.

5. The epoxy resin of claim 2, wherein the silane compound comprises (3-glycidyloxypropyl)trimethoxy silane, N-(2-aminoethyl) 3-amino-propyl dimethoxymethyl silane or a combination thereof.

6. The epoxy resin of claim 1, wherein the triepoxy compound comprises at least one triglycidyl ether compound selected from the group consisting of trimethylolpropane triglycidyl ether, triphenylolmethane triglycidyl ether and trimethylolethane triglycidyl ether.

7. The epoxy resin of claim 1, wherein the aryl sulfonamide compound comprises at least one selected from the group consisting of p-toluene sulfonamide, o-toluene sulfonamide, benzene sulfonamide and naphthalene sulfonamide.

8. The epoxy resin of claim 1, wherein the epoxy compound further comprises a monoepoxy compound, a diepoxy compound or a combination thereof.

9. The epoxy resin of claim 8, wherein the monoepoxy compound comprises at least one glycidyl ether selected from the group consisting of butyl glycidyl ether, phenyl glycidyl ether, ethylhexyl glycidyl ether, allyl glycidyl ether and cresyl glycidyl ether, and the diepoxy compound comprises at least one diglycidyl ether selected from the group consisting of hexanediol diglycidyl ether, butanediol diglycidyl ether, bisphenol A diglycidyl ether, bisphenol F diglycidyl ether, bisphenol AF diglycidyl ether and ethylene glycol diglycidyl ether.

10. The epoxy resin of claim 1, wherein the epoxy compound further comprises at least one epoxy prepolymer selected from the group consisting of bisphenol A (BPA) epoxy resin having a weight average molecular weight less than or equal to about 400, bisphenol F (BPF) epoxy resin having a weight average molecular weight less than or equal to about 400, bisphenol AF (BPAF) epoxy resin having a 15 weight average molecular weight less than or equal to about 400, phenol-based epoxy resin having a weight average molecular weight less than or equal to about 1000, cresol-based epoxy resin having a weight average molecular weight less than or equal to about 1000 and cyclic aliphatic epoxy resin having a weight average molecular weight less than or equal to about 1000.

11. An epoxy resin prepared by reacting about 40 to about 65 parts by weight of an epoxy compound including a triepoxy compound, an epoxy prepolymer and a combination thereof, about 30 to about 55 parts by weight of an aryl sulfonamide, and about 0.01 to about 20 parts by weight of a silane compound represented by a chemical formula 1,
R₁—(CH₂)ₙ—Si(R₂)ₓ(R₃)₃₋ₓ (1)
wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1.

12. The epoxy resin of claim 11, wherein the epoxy compound further comprises a monoepoxy compound, a diepoxy compound or a combination thereof.

13. An epoxy resin composition comprising:
about 50 to about 99.9 parts by weight of an epoxy resin prepared by reacting about 40 to about 70 parts by weight of an epoxy compound including a triepoxy compound and about 30 to about 60 parts by weight of an aryl sulfonamide compound; and
about 0.1 to about 50 parts by weight of at least one additive selected from the group consisting of a viscosity-controlling agent, a plasticizer, a leveling agent, an anti-oxidizing agent and an anti-foaming agent.

14. The epoxy resin composition of claim 13, wherein the viscosity-controlling agent comprises at least one selected from the group consisting of a ketone compound including methyl ethyl ketone, acetone or a combination thereof, an ester compound including butyl acetate, ethyl acetate or a combination thereof, and an aromatic hydrocarbon compound including toluene, xylene or a combination thereof.

15. The epoxy resin composition of claim 13, wherein the plasticizer comprises at least one selected from the group consisting of dioctyl phthalate, dibutyl phthalate, dimethyl phthalate, diethyl phthalate, dioctyl adipate and dioctyl sebacate.

16. An epoxy resin composition comprising:
about 50 to about 99.9 parts by weight of an epoxy resin prepared by reacting about 40 to about 65 parts by weight of an epoxy compound including a triepoxy compound, an epoxy prepolymer or a combination thereof, about 30 to about 55 parts by weight of an aryl sulfonamide compound, and about 0.01 to about 20 parts by weight of a silane compound represented by a chemical formula 1,
R₁—(CH₂)ₙ—Si(R₂)ₓ(R₃)₃₋ₓ (1)
wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1; and
about 0.1 to about 50 parts by weight of at least one additive selected from the group consisting of a viscosity-controlling agent, a plasticizer, a leveling agent, an anti-oxidizing agent and an anti-foaming agent.

17. A method of preparing an epoxy resin comprising reacting about 40 to about 70 parts by weight of an epoxy compound including a triepoxy compound with about 30 to about 60 parts by weight of an aryl sulfonamide.

18. The method of claim 17, wherein reacting the epoxy compound with the aryl sulfonamide compound is performed using at least one catalyst selected from the group consisting of an ammonium salt, a borate salt, a phosphonium compound, an imidazole compound and a tertiary amine compound.

19. The method of claim 18, wherein the catalyst comprises at least one selected from the group consisting of triethylammonium chloride, triethylammonium bromide, triethylammonium iodide, tributylammonium chloride, tributylammonium bromide, tributylammonium iodide, tetraethylammonium tetrafluoroborate, N,N-dimethyl-1,2-diaminoethane-tetrafluoroboric acid, ethyltriphenyl phosphonium chloride, ethyltriphenyl phosphonium iodide, imidazole, 1-methyl imidazole, benzimidazole, trimethylamine, triethylamine, tripropylamine and tributylamine.

20. The method of claim 17, wherein reacting the epoxy compound with the aryl sulfonamide compound is performed at a temperature of about 60° C. to about 150° C.

21. A method of preparing an epoxy resin comprising:
reacting about 40 to about 65 parts by weight of an epoxy compound, about 30 to about 55 parts by weight of an aryl sulfonamide compound, and about 0.01 to about 20 parts by weight of a silane compound represented by a chemical formula 1,
R₁—(CH₂)ₙ—Si(R₂)ₓ(R₃)₃₋ₓ (1)
wherein R₁ represents any one of a vinyl group, a halogen atom, a thiol group, an epoxy group, an acryl group and an amino group, R₂ represents an alkyl group having 1 to 3 carbon atoms, R₃ represents an alkoxy group, n represents an integer of 0 to 3 and x represents 0 or 1.

22. The method of claim 21, wherein reacting the epoxy compound, the aryl sulfonamide compound and the silane compound comprises:
preparing an epoxy-silane compound by reacting the epoxy compound with the silane compound; and
reacting the epoxy-silane compound with the aryl sulfonamide compound.

23. The method of claim 21, wherein reacting the epoxy compound, the aryl sulfonamide compound and the silane compound comprises:
preparing a sulfonamide-silane compound by reacting the aryl sulfonamide compound with the silane compound; and
reacting the sulfonamide-silane compound with the epoxy compound.
